(19) United States
(12) Patent Application Publication
(10) Pub. No.: US 2009/0274213 A1
(43) Pub. Date: Nov. 5, 2009

(54) APPARATUS AND METHOD FOR COMPUTATIONALLY EFFICIENT INTRA PREDICTION IN A VIDEO CODER

(75) Inventors: Jian ZHOU, Fremont, CA (US); Hao-Song KONG, Sunnyvale, CA (US)

Correspondence Address: Curtis A. Vock;LATHROP & GAGE LLP, 4845 Pearl East Circle, Suite 201, Boulder, CO, 80301, US

(73) Assignee: OMNIVISION TECHNOLOGIES, INC., Sunnyvale, CA (US)

(21) Appl. No.: 12/113,202

(22) Filed: Apr. 30, 2008

(51) Int. Cl. H04N 7/26

(52) U.S. Cl. 375/240.15; 375/E07.126

(57) ABSTRACT

A computer readable storage medium has executable instructions to select a plurality of blocks in a video sequence to be coded as intra-coded blocks. Intra prediction modes are selected for all intra-coded blocks in a macroblock based on original pixels of neighboring blocks. The mode selection of all intra-coded blocks can be conducted in parallel. The intra-coded blocks in the macroblock are predicted with the selected intra prediction modes based on reconstructed pixels of neighboring blocks.

### FIELD OF THE INVENTION

This invention relates generally to intra prediction in a video coder. More particularly, this invention relates to an apparatus and method for parallelizing the intra mode decision process of each intra-coded macroblock in a video sequence.

### BACKGROUND OF THE INVENTION

Digital video coding technology enables the efficient storage and transmission of the vast amounts of visual data that compose a digital video sequence. With the development of international digital video coding standards, digital video has now become commonplace in a host of applications, ranging from video conferencing and DVDs to digital TV, mobile video, and Internet video streaming and sharing. Digital video coding standards provide the interoperability and flexibility needed to fuel the growth of digital video applications worldwide.

There are two international organizations currently responsible for developing and implementing digital video coding standards: the Video Coding Experts Group (“VCEG”) under the authority of the International Telecommunication Union-Telecommunication Standardization Sector (“ITU-T”) and the Moving Pictures Experts Group (“MPEG”) under the authority of the International Organization for Standardization (“ISO”) and the International Electrotechnical Commission (“IEC”). The ITU-T has developed the H.26x (e.g., H.261, H.263) family of video coding standards and the ISO/IEC has developed the MPEG-x (e.g., MPEG-1, MPEG-4) family of video coding standards. The H.26x standards have been designed mostly for real-time video communication applications, such as video conferencing and video telephony, while the MPEG standards have been designed to address the needs of video storage, video broadcasting and video streaming applications.

The ITU-T and the ISO/IEC have also joined efforts in developing high-performance, high-quality video coding standards, including the previous H.262 (or MPEG-2) and the recent H.264 (or MPEG-4 Part 10/AVC) standard. The H.264 video coding standard, adopted in 2003, provides high video quality at substantially lower bit rates (up to 50%) than previous video coding standards. The H.264 standard provides enough flexibility to be applied to a wide variety of applications, including low and high bit rate applications as well as low and high resolution applications. New applications may be deployed over existing and future networks.

The H.264 video coding standard has a number of advantages that distinguish it from other existing video coding standards, while sharing common features with those standards. The basic video coding structure of H.264 is illustrated in FIG. 1. H.264 video coder 100 divides each video frame of a digital video sequence into 16×16 blocks of pixels (referred to as “macroblocks”) so that processing of a frame may be performed at a block level.

Each macroblock may be coded as an intra-coded macroblock by using information from its current video frame or as an inter-coded macroblock by using information from its previous frames. Intra-coded macroblocks are coded to exploit the spatial redundancies that exist within a given video frame through transform, quantization, and entropy (or variable-length) coding. Inter-coded macroblocks are coded to exploit the temporal redundancies that exist between macroblocks in successive frames, so that only changes between successive frames need to be coded. This is accomplished through motion estimation and compensation.

In order to increase the efficiency of the intra coding process for the intra-coded macroblocks, spatial correlation between adjacent macroblocks in a given frame is exploited by using intra prediction 105. Since adjacent macroblocks in a given frame tend to have similar visual properties, a given macroblock in a frame may be predicted from already coded, surrounding macroblocks. The difference or residual between the given macroblock and its prediction is then coded, thereby resulting in fewer bits to represent the given macroblock as compared to coding it directly. A block diagram illustrating intra prediction in more detail is shown in FIG. 2.

Intra prediction may be performed for an entire 16×16 macroblock or it may be performed for each 4×4 block within a 16×16 macroblock. These two different prediction types are denoted by “Intra_{—}16×16” and “Intra_{—}4×4”, respectively. The Intra_{—}16×16 mode is more suited for coding very smooth areas of a video frame, while the Intra_{—}4×4 mode is more suited for coding areas of a video frame having significant detail.

In the Intra_{—}4×4 mode, each 4×4 block is predicted from spatially neighboring samples as illustrated in FIGS. 3A-3B. The sixteen samples of the 4×4 block 300 which are labeled as “a-p” are predicted using prior decoded, i.e., reconstructed, samples in adjacent blocks labeled as “A-Q.” That is, block X 305 is predicted from reconstructed pixels of neighboring blocks A 310, B 315, C 320, and D 325. Specifically, intra prediction is performed using data in blocks above and to the left of the block being predicted, by, for example, taking the lower right pixels of the block above and to the left of the block being predicted, the lower row of pixels of the block above the block being predicted, the lower row of pixels of the block above and to the right of the block being predicted, and the right column of pixels of the block to the left of the block being predicted.

For each 4×4 block in a macroblock, one of nine intra prediction modes defined by the H.264 video coding standard may be used. The nine intra prediction modes are illustrated in FIG. 4. In addition to a “DC” prediction mode (Mode 2), eight directional prediction modes are specified. Those modes are suitable to predict directional structures in a video frame such as edges at various angles.

Typical H.264 video coders select one from the nine possible Intra_{—}4×4 prediction modes according to some criterion to code each 4×4 block within an intra-coded macroblock, in a process commonly referred to as intra coding “mode decision” or “mode selection”. Once the intra prediction mode is selected, the prediction pixels are taken from the reconstructed version of the neighboring blocks to form the prediction block. The residual is then obtained by subtracting the prediction block from the current block, as illustrated in FIG. 2.

The mode decision criterion usually involves optimization of a cost to code the residual, as illustrated in FIG. 5 with the pseudo code implemented in the JM reference encoder publicly available at http://iphome.hhi.de/suehring/tml/. The residual is the difference of the pixel values between the current block and the predicted block formed by the reconstructed pixels in the neighboring blocks. The cost evaluated can be a Sum of the Absolute Differences (“SAD”) cost between the original block and the predicted block, a Sum of the Square Differences (“SSE”) cost between the original block and the predicted block, or, more commonly utilized, a rate-distortion cost.

The rate-distortion cost evaluates the Lagrange cost for predicting the block with each candidate mode out of the nine possible modes and selects the mode that yields the minimum Lagrange cost. Because of the large number of available modes for coding a macroblock, the process for determining the cost needs to be performed many times. The computation involved in the intra mode decision stage is therefore very intensive.

Furthermore, since the prediction of a block relies on its neighboring blocks, i.e., the left, up, up-right, and up-left neighboring blocks as shown in FIGS. 3A-B, the prediction of block X 305 cannot be processed until all of its neighboring blocks A 310, B 315, C 320, and D 325 are reconstructed. In case there are multiple processing units available for executing the coding mode decision stage, these multiple processing units are underutilized as the coding mode decision stage is implemented almost sequentially.

For example, suppose there are a total of sixteen processing units available for executing the coding mode decision stage. Each processing unit is supposed to perform the coding mode decision for a given block in parallel. FIG. 6 illustrates how the coding mode decision is typically performed with multiple processing units. The coding mode decision process starts at stage 600 with the first block at a given macroblock, i.e., block 605 labeled as block ‘0’. Since no neighbors are available at this initial stage, only one processing unit is used for calculating the residual and the cost of coding the residual by using each one of the available prediction modes, e.g., the nine prediction modes specified by the H.264 video coding standard and illustrated in FIG. 4, before selecting a prediction mode to predict the block ‘0’ (605). The other fifteen processing units are idle.

After completing the coding of block ‘0’ (605), the coding mode decision process moves to stage 610 and proceeds to code block 615, labeled as block ‘1’. At this point, only block ‘0’ (605) is available to block ‘1’ (615). Therefore, only one processing unit is needed. The other fifteen processing units are still idle.

When both block ‘0’ (605) and block ‘1’ (615) are reconstructed, the coding mode precision process moves to stage 620 and proceeds to code block 625, labeled as block ‘2’, and block 630, labeled as block ‘4’. In this case, two processing units can be used to perform the coding mode decision process in parallel for blocks ‘2’ (625) and ‘4’ (630). The other fourteen processing units are still idle. The same situation applies for the next stage of the coding mode decision process, stage 635, for coding blocks ‘3’ (640) and ‘5’ (645) in parallel with two processing units, while the other fourteen processing units remain idle, as well as for subsequent stages of the coding mode decision process, for coding blocks ‘6’ and ‘8’, ‘7’ and ‘9’, and so on.

Due to the dependency of the coding mode decision process on the reconstructed neighboring blocks, it becomes clear that the sixteen 4×4 blocks in a given 16×16 macroblock cannot be fully processed in parallel. The computational times for processing a macroblock with Intra_{—}4×4 prediction are illustrated in FIG. 7. Regardless of how many processing units are available, the maximum number of blocks that may be processed in parallel in the Intra_{—}4×4 prediction mode is two blocks. A total of ten stages are required to process an entire macroblock. Each stage has two parts, mode decision and coding. The mode decision stage consists of the time to generate the residual and the cost for coding the residual with each one of the nine available intra prediction modes. An intra prediction mode is selected to predict each block in the macroblock based on the cost for coding the residual for the block. Once the intra prediction modes are determined for the macroblock, the corresponding residuals are then processed by the coding modules, including DCT/Quantization/Inverse Quantization/Inverse DCT stages, each with a computational time of one block size. This results in a total computational time of 220 units to perform intra 4×4 prediction for a macroblock.

Accordingly, it would be desirable to provide techniques to de couple the coding mode decision process' dependency on reconstructed neighboring blocks and achieve a higher parallelization of the coding mode decision process.

### SUMMARY OF THE INVENTION

The invention includes a computer readable storage medium with executable instructions to select a plurality of blocks in a video sequence to be coded as intra-coded blocks. Intra prediction modes are selected for all intra-coded blocks in a macroblock based on original pixels of neighboring blocks. The intra-coded blocks in the macroblock are coded with the selected intra prediction modes based on reconstructed pixels of neighboring blocks.

An embodiment of the invention includes a method for performing intra prediction on intra-coded blocks in a video sequence. An intra prediction mode is selected for each intra-coded block in a macroblock based on original pixels of neighboring blocks. Each intra-coded block is predicted with the selected intra prediction mode based on reconstructed pixels of neighboring blocks.

Another embodiment of the invention includes a method for parallelizing the intra coding mode decision for intra-coded blocks in a video sequence. The intra-coded blocks in a macroblock are processed in parallel to select an intra prediction mode for each intra-coded block in the macroblock based on original pixels of neighboring blocks. The intra-coded blocks in the macroblock are processed in parallel to predict the intra-coded blocks with their selected intra prediction modes.

Another embodiment of the invention includes a video coding apparatus having an interface for receiving a video sequence and a processor for coding the video sequence. The processor has executable instructions to select a plurality of blocks from the video sequence to be coded as intra-coded blocks and to select intra prediction modes for all intra-coded blocks in a macroblock based on original pixels of neighboring blocks.

### BRIEF DESCRIPTION OF THE DRAWINGS

The invention is more fully appreciated in connection with the following detailed description taken in conjunction with the accompanying drawings, in which like reference characters refer to like parts throughout, and in which:

FIG. 1 illustrates the basic video coding structure of the H.264 video coding standard;

FIG. 2 illustrates a block diagram of intra prediction in the H.264 video coding standard;

FIG. 3A illustrates a 4×4 block predicted from spatially neighboring samples according to the H.264 video coding standard;

FIG. 3B illustrates a 4×4 block predicted from neighboring blocks according to the H.264 video coding standard;

FIG. 4 illustrates the nine Intra_{—}4×4 prediction modes of the H.264 video coding standard;

FIG. 5 illustrates pseudo-code used for the Intra_{—}4×4 coding mode decision stage of a reference H.264 encoder;

FIG. 6 illustrates a schematic diagram for the Intra_{—}4×4 coding mode decision stage of a H.264 encoder using multiple processing units;

FIG. 7 illustrates a table showing computational times for processing a macroblock with Intra_{—}4×4 prediction;

FIG. 8 illustrates a flow chart for performing Intra_{—}4×4 prediction in a video coder in accordance with an embodiment of the invention;

FIG. 9 illustrates the 4×4 intra-coded blocks in a 16×16 macroblock in accordance with an embodiment of the invention;

FIG. 10 illustrates a table showing computational times for processing a macroblock with Intra_{—}4×4 prediction in accordance with an embodiment of the invention; and

FIG. 11 illustrates a block diagram of a video coding apparatus in accordance with an embodiment of the invention.

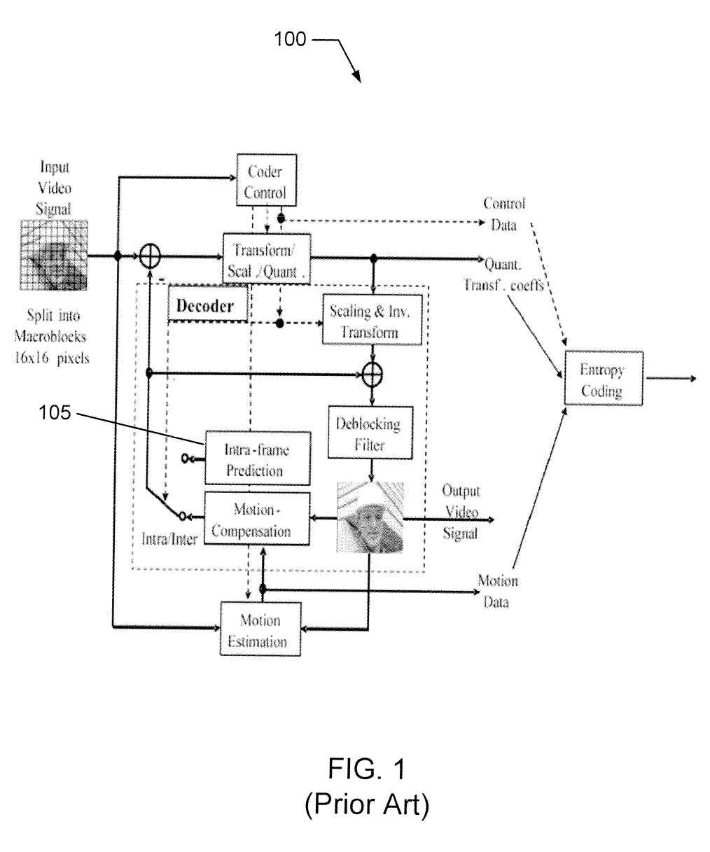

### DETAILED DESCRIPTION OF THE INVENTION

The present invention provides an apparatus, method, and computer readable storage medium for performing computationally efficient intra prediction in a video coder. As generally used herein, intra prediction refers to the prediction of a block in a macroblock of a digital video sequence using a given intra prediction mode. The intra prediction mode may be selected from a plurality of intra prediction modes, such as the prediction modes specified by a given video coding standard or video coder, e.g., the H.264 video coding standard, for coding a video sequence. The block may be a 4×4 block or a 16×16 block from a 16×16 macroblock, or any other size block or macroblock as specified by the video coding standard or video coder.

According to an embodiment of the invention, an intra prediction mode is selected for each intra-coded block in a given intra-coded macroblock based on the original pixels of the neighboring blocks. This is accomplished by using the original, non-reconstructed pixels of the neighboring blocks to form prediction blocks for a given intra-coded block, the prediction blocks corresponding to a plurality of intra prediction modes. An intra prediction mode is then selected based on the intra prediction costs for coding the block with the intra prediction modes. The intra prediction mode that yields the lowest intra prediction cost is the one selected for coding the intra-coded block.

In one embodiment, the intra prediction costs for a given intra-coded block are computed by predicting the block relative to the original, non-reconstructed neighboring blocks to form the prediction blocks and coding the residual between the prediction blocks and the given block. As generally used herein, an intra prediction cost for a given intra-coded block refers to the intra prediction cost associated with a given intra prediction mode selected for coding the block. The cost computed can be a Sum of the Absolute Differences (“SAD”) cost between the original block and the predicted block, a Sum of the Square Differences (“SSE”) cost between the original block and the prediction block, or, more commonly utilized, a rate-distortion cost.

That is, during the mode decision stage, instead of using the reconstructed pixels of neighboring blocks to predict the intra-coded block as traditionally performed in prior-art intra coding mode decision stages, intra prediction in the present invention is formed based on the original, non-reconstructed pixels of the neighboring blocks. As described in more detail herein below, doing so enables the intra coding mode decision stage of a video coder to be fully parallelized, as all the intra-coded blocks in the macroblock may be jointly processed in parallel.

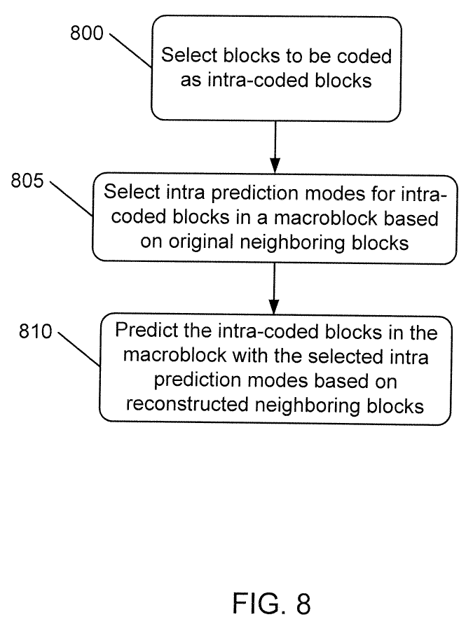

FIG. 8 illustrates a flow chart for performing intra prediction in a video coder in accordance with an embodiment of the invention. First, for a given video coding sequence, a plurality of blocks are selected to be coded as intra-coded blocks in step 800. The plurality of blocks are selected from a plurality of macroblocks in a plurality of video frames. For example, as appreciated by one of ordinary skill in the art, a given video sequence may have a plurality of frames that are intra-coded and a plurality of frames that are inter-coded. The plurality of intra-coded frames have a plurality of intra-coded macroblocks. Each intra-coded macroblock has, in turn, a plurality of intra-coded blocks.

For example, as specified in the H.264 and other like video coding standards, e.g., the MPEG family of video coding standards, a macroblock may be a 16×16 macroblock having sixteen 4×4 or one 16×16 intra-coded block(s). Each intra-coded block may be coded as specified in the video coding standard, such as, for example, by using intra prediction.

Next, intra prediction modes are selected for the intra-coded blocks in a macroblock based on the original, non-reconstructed pixels of neighboring blocks in step 805. This is accomplished by selecting an intra prediction mode for each intra-coded block from a pool of candidate intra prediction modes, such as, for example, the nine intra prediction modes specified in the H.264 standard. A given intra-coded block is then predicted with each candidate intra prediction mode using the original, non-reconstructed pixels of its neighboring blocks to form a prediction block. A residual is generated between the prediction block and the original intra-coded block. Intra prediction costs are computed for all the residuals generated for the candidate intra prediction modes. The intra prediction mode selected to predict the intra-coded block is the one that yields the lowest intra prediction cost out of all the candidate intra prediction modes.

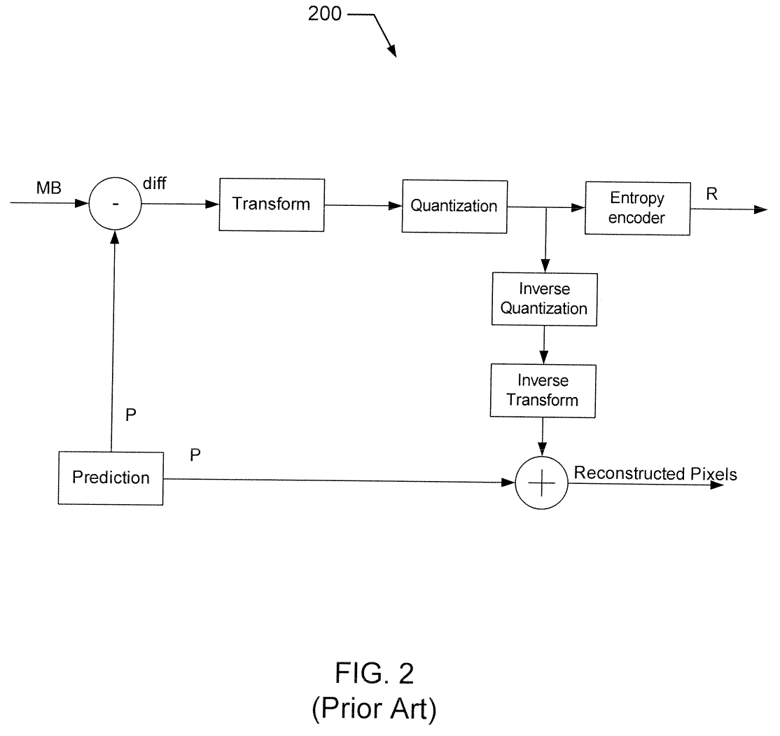

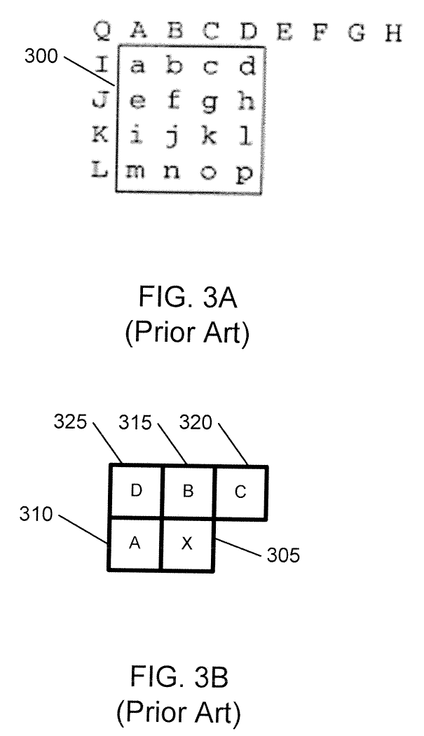

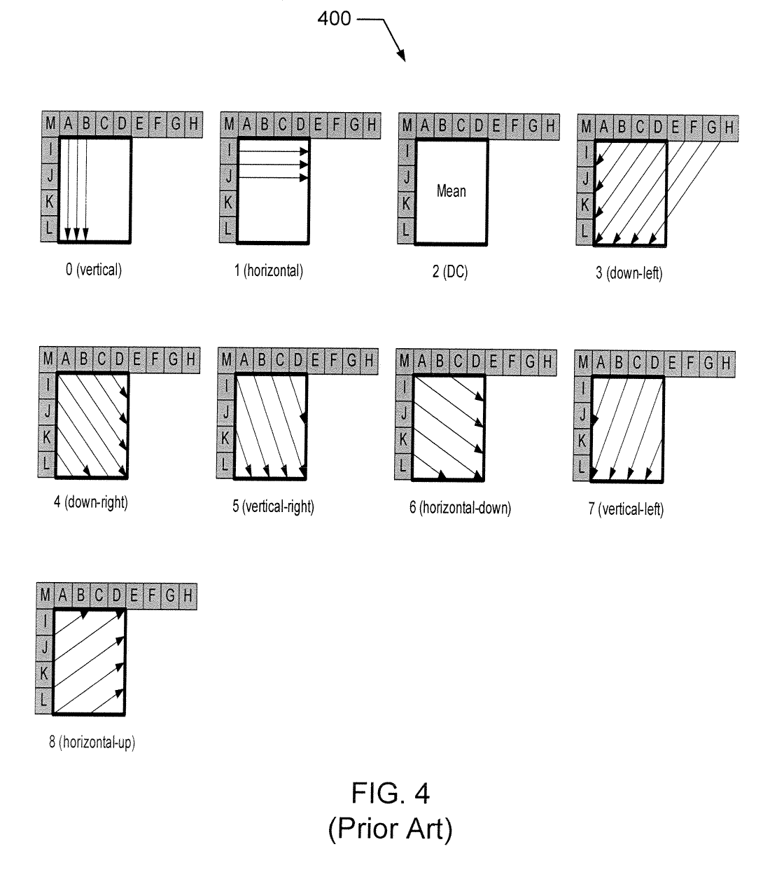

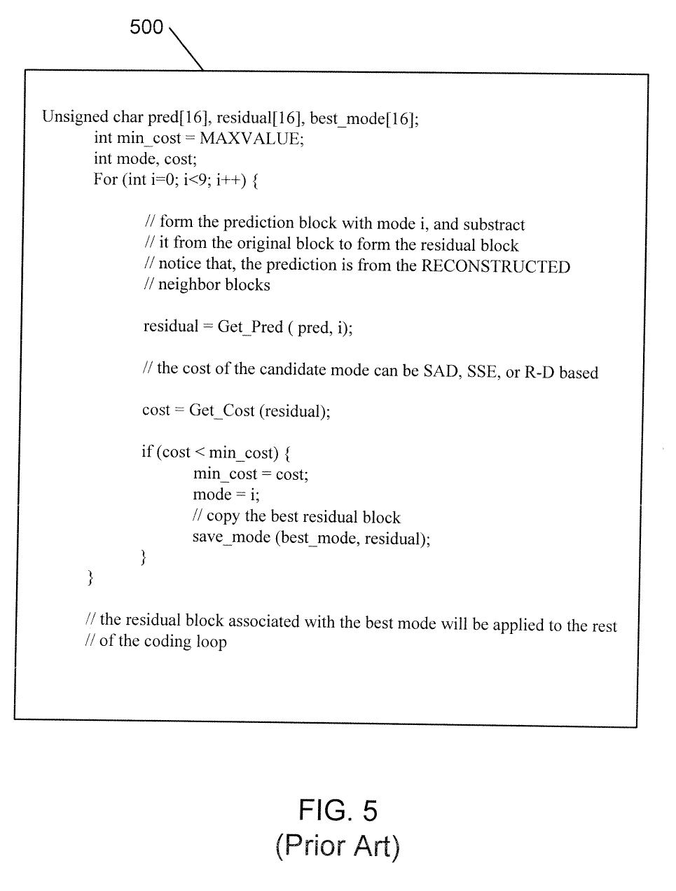

Lastly, the intra-coded blocks in the macroblock are predicted with their selected intra prediction modes in step 810. The intra-coded blocks are predicted based on the reconstructed pixels of the neighboring blocks, as described in more detail herein above with reference to FIG. 2. It is appreciated that although at the mode decision stage, the intra prediction modes of a given macroblock may be selected based on the original, non-reconstructed pixels of the neighboring blocks, the intra prediction of the blocks in the given macroblock at the final coding stage is performed based on the reconstructed pixels of the neighboring blocks, such as, for example, the intra prediction dictated by the H.264 standard and described herein above with reference to FIG. 2.

Additionally, it is appreciated that because the reconstructed pixels of the neighboring blocks are used to predict the blocks in a given macroblock, the same reconstructed pixels are also used to select the intra prediction mode for those blocks in traditional intra prediction approaches in the prior art. The embodiments presented herein, however, decouple the intra prediction mode selection from the intra prediction itself to achieve computational savings not contemplated by any of the traditional intra prediction approaches available in the prior art.

It is further appreciated that, in contrast to traditional intra mode selection performed in prior art approaches, the intra prediction modes selected for the macroblock may be selected simultaneously. That is, the selection of intra prediction modes for some or all of the blocks in a given macroblock may be performed in parallel. Because the original, non-reconstructed pixels of the neighboring blocks are used to select the intra prediction modes for a given macroblock, rather than the reconstructed pixels of the neighboring blocks as in traditional intra prediction prior art approaches, all the neighboring blocks are available at the same time and the intra prediction may be parallelized.

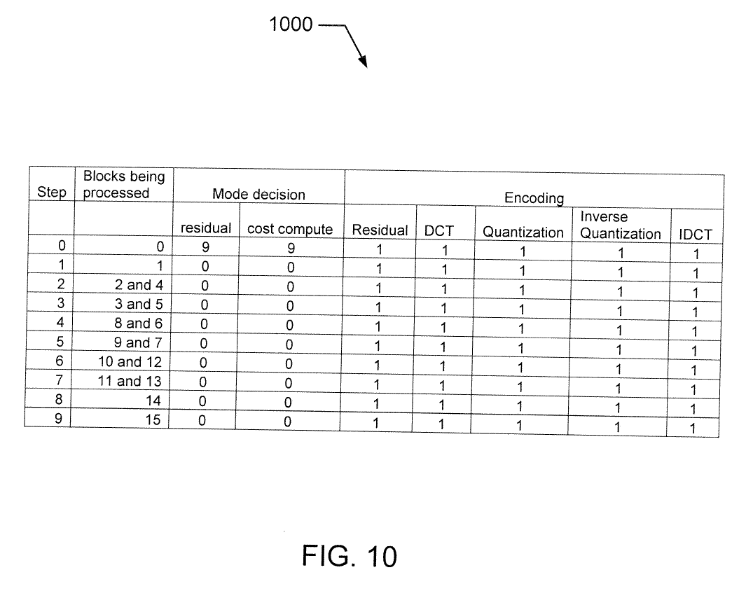

In doing so, the intra coding mode decision stage of a video coder may be implemented much more efficiently with less computational time, as described below with reference to FIG. 10. According to an embodiment of the invention, the intra coding mode decision stage may be fully parallelized for all blocks of a given macroblock. In this case, the intra prediction modes for all the blocks of the given macroblock may be simultaneously selected. For example, for sixteen 4×4 blocks in a 16×16 macroblock, multiple processing units, e.g., sixteen processing units, may be used to perform the parallel computations for the sixteen 4×4 blocks simultaneously.

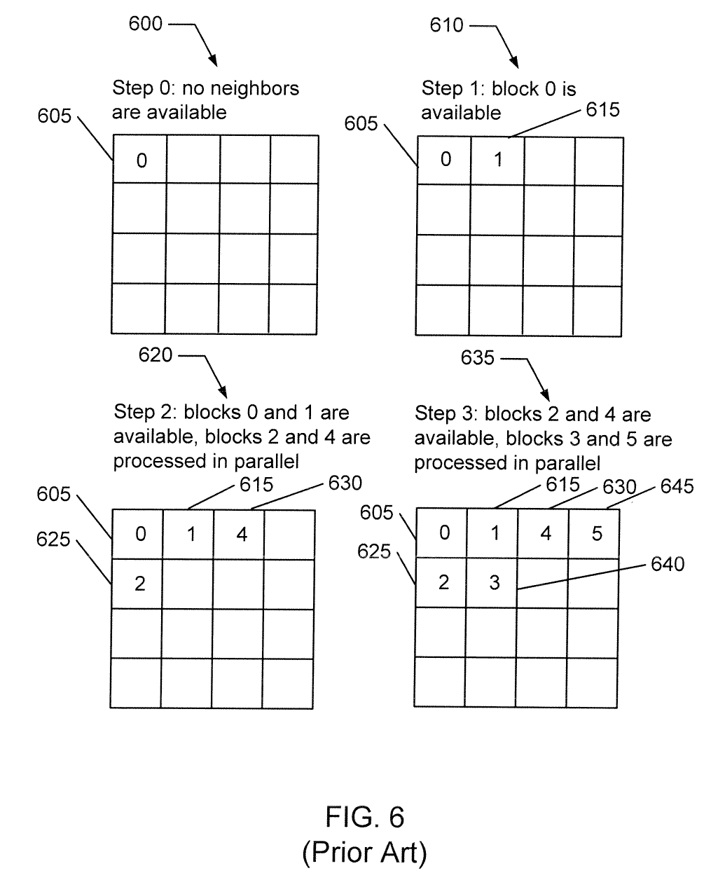

It is also appreciated that, after the intra prediction mode is determined, the prediction residual is formed in the same way as that performed in prior art approaches, i.e., the formation of the residual used for generating the compressed bit-stream of the blocks in a given macroblock depends on the reconstruction of the neighboring blocks. As such, up to two blocks in the given macroblock may be processed in parallel, as described in more detail herein above with reference to FIG. 6.

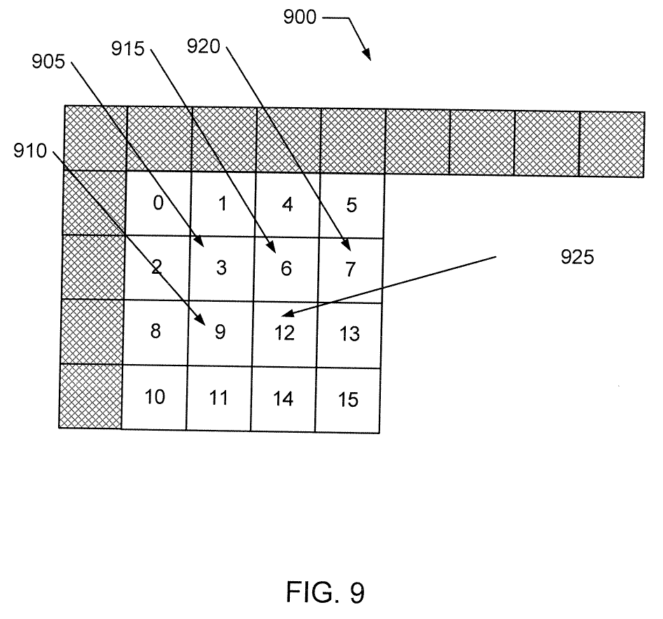

Referring now to FIG. 9, the 4×4 intra-coded blocks in a 16×16 macroblock in accordance with an embodiment of the invention are described. Macroblock 900 is a 16×16 macroblock having sixteen 4×4 intra-coded blocks, labeled from 0-15. Blocks 0-15 may all be processed in parallel in the intra prediction coding mode decision stage of a video coder. As described herein above, this is accomplished by selecting the intra prediction modes for blocks 0-15 based on the original, non-reconstructed pixels of their neighboring blocks (shaded blocks), rather than the reconstructed pixels of their neighboring blocks, as traditionally performed in prior art intra prediction approaches.

For every block 0-15 in macroblock 900, the original, non-reconstructed pixels of the neighboring blocks are all available to perform the intra coding mode decision in parallel. For example, neighboring blocks 905, 910, 915 and 920 are available simultaneously to aid in the intra prediction of block 925 in macroblock 900. That is, a processor performing the intra coding mode decision, in contrast to traditional approaches in the prior art such as described with reference to FIG. 6, does not have to wait for the neighboring blocks to be reconstructed. The processor can simultaneously select the intra prediction modes for all the 0-15 blocks in macroblock 900.

Referring now to FIG. 10, a table showing computational times for processing a macroblock with Intra_{—}4×4 prediction in accordance with an embodiment of the invention is described. Table 1000 shows the computational times when sixteen 4×4 blocks of a 16×16 macroblock are processed together in an intra coding mode decision stage of a video coder. Because all the blocks are processed together, it only takes a computational time of, for example, 9 units to process all 9 intra prediction modes specified in the H.264 standard for all the sixteen 4×4 blocks in the 16×16 macroblock, resulting in a total computational time of 59 units.

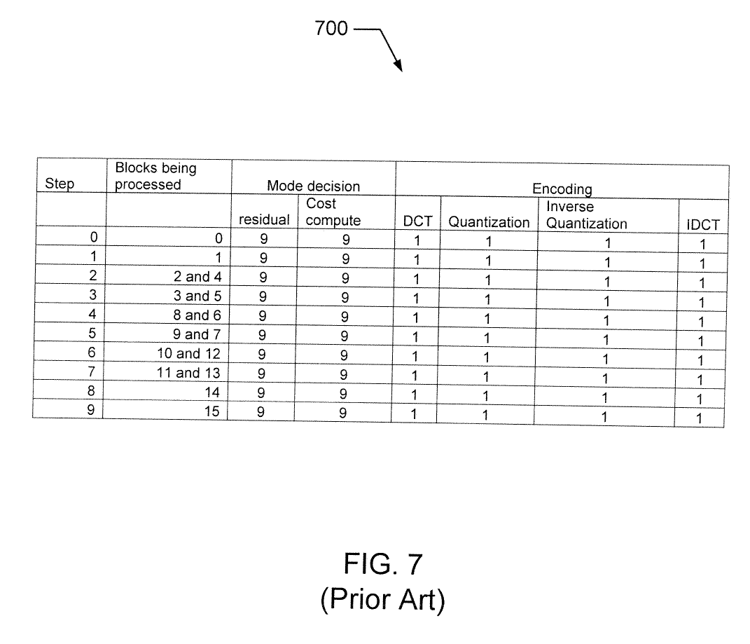

This is in sharp contrast to the total computational time of 220 units shown in Table 700 of FIG. 7 for traditional intra prediction approaches. Using the original, non-reconstructed pixels of the neighboring blocks to perform the intra coding mode decision stage of a video coder results in a total computational and time savings of 73.18%, as compared with traditional intra prediction approaches based solely on the reconstructed pixels of the neighboring blocks.

It is appreciated that because the reconstructed pixels of the neighboring blocks are used to predict the blocks in a given macroblock, the same reconstructed pixels are also used to select the intra prediction mode for those blocks in traditional intra prediction approaches in the prior art. As such, the embodiments presented herein for using the original, non-reconstructed pixels of the neighboring blocks to select the intra prediction modes for a given macroblock, decouple the intra prediction mode selection from the intra prediction itself to achieve computational savings not contemplated by any of the traditional intra prediction approaches available in the prior art.

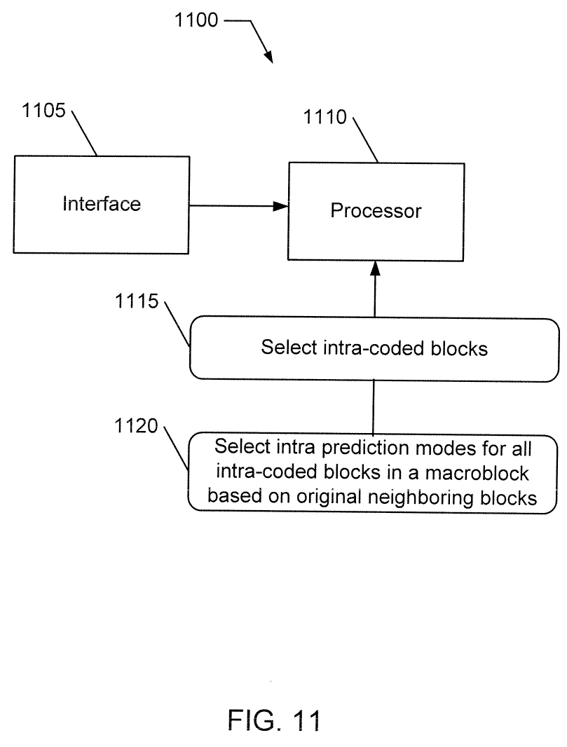

Referring now to FIG. 11, a block diagram of a video coding apparatus in accordance with an embodiment of the invention is described. Video coding apparatus 1100 has an interface 1105 for receiving a video sequence and a processor 1110 for coding the video sequence. Interface 1105 may be, for example, an image sensor in a digital camera or other such image sensor device that captures optical images, an input port in a computer or other such processing device, or any other interface connected to a processor and capable of receiving a video sequence.

In accordance with an embodiment of the invention and as described above, processor 1110 has executable instructions or routines for selecting intra prediction modes for a given macroblock. For example, processor 1110 has a routine 1115 for selecting frames, macroblocks, and blocks in the video sequence to be intra-coded by using intra prediction and a routine 1120 for selecting an intra prediction mode for each block in a given macroblock based on the original, non-reconstructed pixels of the neighboring blocks.

It is appreciated that processor 1110 may have multiple processing units to perform the intra prediction mode selection and the intra prediction of the blocks in a given macroblock in parallel. For example, as described herein above, processor 1110 may include sixteen processing units to process all sixteen 4×4 blocks of a 16×16 macroblock simultaneously.

It is also appreciated that video coding apparatus 100 may be a stand-alone apparatus or may be a part of another device, such as, for example, digital cameras and camcorders, hand-held mobile devices, webcams, personal computers, laptops, mobile devices, personal digital assistants, and the like.

Advantageously, the present invention enables intra prediction modes to be selected for a macroblock much more efficiently than traditional intra prediction approaches. In contrast to traditional intra prediction approaches, the intra prediction modes for the macroblock are selected based on the original pixels of the neighboring blocks. In doing so, the intra mode decision can be fully parallelized, thereby achieving computational savings of more than 70% over the traditional intra prediction approaches.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

What is claimed is:

1. A computer readable storage medium, comprising executable instructions to:
select a plurality of blocks in a video sequence to be coded as intra-coded blocks;
select intra prediction modes for all intra-coded blocks in a macroblock based on original pixels of neighboring blocks; and
predict the intra-coded blocks in the macroblock with the selected intra prediction modes based on reconstructed pixels of neighboring blocks.

2. The computer readable storage medium of claim 1, wherein the video sequence comprises a plurality of intra-coded frames, each intra-coded frame comprising a plurality of macroblocks.

3. The computer readable storage medium of claim 2, wherein the executable instructions to select a plurality of blocks in a video sequence to be coded as intra-coded blocks comprise executable instructions to select the intra-coded blocks from a macroblock.

4. The computer readable storage medium of claim 1, wherein the executable instructions to predict the intra-coded blocks in the macroblock with the selected intra prediction modes comprise executable instructions to simultaneously predict two intra-coded blocks at a time.

5. The computer readable storage medium of claim 1, wherein the executable instructions to select intra prediction modes for all intra-coded blocks in a macroblock comprise executable instructions to simultaneously select the intra prediction modes for all the intra-coded blocks in the macroblock using the original pixels of the neighboring blocks, each prediction block corresponding to an intra prediction mode.

6. The computer readable storage medium of claim 5, further comprising executable instructions to simultaneously form residual blocks for each intra-coded block in the macroblock by subtracting the prediction blocks from the intra-coded block, each residual block corresponding to an intra prediction mode.

7. The computer readable storage medium of claim 6, further comprising executable instructions to simultaneously compute intra prediction costs for coding the residual blocks for each intra-coded block, each intra prediction cost corresponding to an intra prediction mode.

8. The computer readable storage medium of claim 7, further comprising executable instructions to select an intra prediction mode for each intra-coded block based on the intra prediction costs.

9. A method for performing intra prediction on intra-coded blocks in a video sequence, comprising:
selecting an intra prediction mode for each intra-coded block in a macroblock based on original pixels of neighboring blocks; and
predicting each intra-coded block with the selected intra prediction mode based on reconstructed pixels of neighboring blocks.

10. The method of claim 9, wherein selecting an intra prediction mode for each intra-coded block comprises performing the selection of intra prediction modes for all the intra-coded blocks in the macroblock in parallel.

11. The method of claim 9, wherein selecting an intra prediction mode for each intra-coded block comprises simultaneously predicting all intra-coded blocks in the macroblock using the original pixels of the neighboring blocks to form prediction blocks for each intra-coded block, each prediction block corresponding to an intra prediction mode.

12. The method of claim 11, further comprising simultaneously forming residual blocks for each intra-coded block in the macroblock by subtracting the prediction blocks from the intra-coded block, each residual block corresponding to an intra prediction mode.

13. The method of claim 12, further comprising simultaneously computing intra prediction costs for coding the residual blocks for each intra-coded block, each intra prediction cost corresponding to an intra prediction mode.

14. The method of claim 13, wherein selecting an intra prediction mode for each intra-coded block comprises selecting the intra prediction mode based on the intra prediction costs.

15. A method for parallelizing the intra coding mode decision for intra-coded blocks in a video sequence, comprising:
processing intra-coded blocks in a macroblock in parallel to select an intra prediction mode for each intra-coded block in the macroblock based on original pixels of neighboring blocks; and
processing intra-coded blocks in the macroblock in parallel to predict the intra-coded blocks with their selected intra prediction modes.

16. The method of claim 15, wherein processing intra-coded blocks in a macroblock in parallel comprises simultaneously predicting a set of intra-coded blocks in the macroblock using the original pixels of the neighboring blocks to form prediction blocks for each intra-coded block in the set of intra-coded blocks, each prediction block corresponding to an intra prediction mode.

17. The method of claim 16, further comprising simultaneously forming residual blocks for each intra-coded block in the set of intra-coded blocks by subtracting the prediction blocks from the each intra-coded block, each residual block corresponding to an intra prediction mode.

18. The method of claim 17, further comprising simultaneously computing intra prediction costs for coding the residual blocks for each intra-coded block in the set of intra-coded blocks, each intra prediction cost corresponding to an intra prediction mode.

19. The method of claim 18, further comprising selecting an intra prediction mode for each intra-coded block in the set of intra-coded blocks based on the intra prediction costs.

20. The method of claim 15, wherein processing intra-coded blocks in the macroblock in parallel comprises separately predicting the first and second intra-coded blocks in the macroblock and predicting the other intra-coded blocks in the macroblock in parallel by simultaneously predicting two intra-coded blocks at a time.

21. A video coding apparatus, comprising:
an interface for receiving a video sequence; and
a processor for coding the video sequence, comprising executable instructions to
select a plurality of blocks in the video sequence to be coded as intra-coded blocks; and
select intra prediction modes for intra-coded blocks in a macroblock based on original pixels of neighboring blocks.

22. The video coding apparatus of claim 21, wherein the processor further comprises executable instructions to predict all intra-coded blocks in the macroblock with the selected intra prediction modes based on reconstructed pixels of neighboring blocks.

23. The video coding apparatus of claim 21, wherein the executable instructions to predict all intra-coded blocks in the macroblock are performed in parallel.
